(19) United States
(12) Patent Application Publication
(10) Pub. No.: US 2005/0218213 A1
(43) Pub. Date: Oct. 6, 2005

(54) System and method for mailing account cards

(75) Inventors: Lucy M. Rasnake, Doswell, VA (US); Rowlin T. Robinson III, Glen Allen, VA (US); Marty L. Manuel, Richmond City, VA (US); Patrick J. Gemmell, Richmond City, VA (US); Richard G. Gamble, Mechanicsville, VA (US); Matthew J. Babecki, Chesterfield, VA (US)

Correspondence Address: BAKER BOTTS L.L.P., 2001 ROSS AVENUE, SUITE 600, DALLAS, TX, 75201-2980, US

(73) Assignee: CAPITAL ONE FINANCIAL CORPORATION

(21) Appl. No.: 11/070,965

(22) Filed: Mar. 3, 2005

Related U.S. Application Data
(60) Provisional application No. 60/559,489, filed on Apr. 5, 2004.

(51) Int. Cl. G06K 5/00

(52) U.S. Cl. 235/380

(57) ABSTRACT

A system for mailing account cards includes an account identification module that is operable to select an account scheduled for a card reissue. The system also includes an embossing module that is operable to generate one or more reissue cards associated with the selected account. Moreover, the system includes a reissue on statements generation module that is operable to print the billing statement associated with the selected account and to combine the billing statement and the one or more reissue cards for insertion into a common mailing.

### CROSS-REFERENCE TO RELATED APPLICATIONS

This application claims the benefit of priority under 35 U.S.C. §119(e) of U.S. Provisional Application Ser. No. 60/559,489, filed Apr. 5, 2004.

### TECHNICAL FIELD OF THE INVENTION

This invention relates generally to account card processing and more particularly to a system and method for combining a reissue card with a billing statement.

### OVERVIEW

Conventional account mailing systems are often capable of creating, printing, and mailing monthly billing statements associated with particular accounts. Moreover, some of the conventional account mailing systems are capable of creating, printing, and mailing new account and reissue cards. However, such account mailing systems typically include a billing system that handles the provisioning of monthly billing statements that is separate and independent from an embossing system that handles the provisioning of new account and reissue cards. That is, the monthly billing statement is provided to a particular account owner in a mailing that is separate from a mailing to the account owner that contains new account and reissue cards.

### SUMMARY OF EXAMPLE EMBODIMENTS

According to a system embodiment, a system for mailing account card comprises an account identification module that is operable to select an account that is scheduled for a card reissue. The system also comprises an embossing module that is operable to generate one or more reissue cards associated with the selected account. The system further comprises a reissue on statements (ROS) generation module that is operable to print the billing statement associated with the selected account and to combine the billing statement and the one or more reissue cards for insertion into a common mailing.

According to one exemplary method embodiment, a method for mailing account cards comprises selecting an account that is scheduled for a card reissue from a plurality of accounts. The method further comprises generating one or more reissue cards associated with the selected account. Moreover, the method comprises formatting information associated with the selected account. The method also comprises printing a billing statement for the selected account and combining the billing statement and the one or more reissue cards associated with the selected account into a common mailing.

Depending on the specific features implemented, particular embodiments may exhibit some, none, or all of the following technical advantages. Various embodiments may be capable of reducing the costs associated with providing reissue cards to account owners. Some embodiments may be capable of improving the account owner activation rate of reissue cards. Other technical advantages will be readily apparent to one skilled in the art from the following figures, description and claims. Moreover, while specific advantages have been enumerated, various embodiments may include all, some or none of the enumerated advantages.

### BRIEF DESCRIPTION OF THE DRAWINGS

For a more complete understanding of the present invention, and for further features and advantages thereof, reference is now made to the following description taken in conjunction with the accompanying drawings, in which:

FIG. 1 is a block diagram of one embodiment of a mailing system capable of combining a billing statement with one or more reissue cards in a common mailing;

FIG. 2 is a block diagram of one embodiment of a reissue on statements processing module capable of combining a billing statement with one or more reissue cards in a common mailing;

FIG. 3 is one embodiment of a billing statement capable of being combined with one or more reissue cards in a common mailing; and

FIG. 4 is a flow chart illustrating an exemplary method for combining a billing statement and one or more reissue cards in a common mailing.

### DETAILED DESCRIPTION OF EXAMPLE EMBODIMENTS

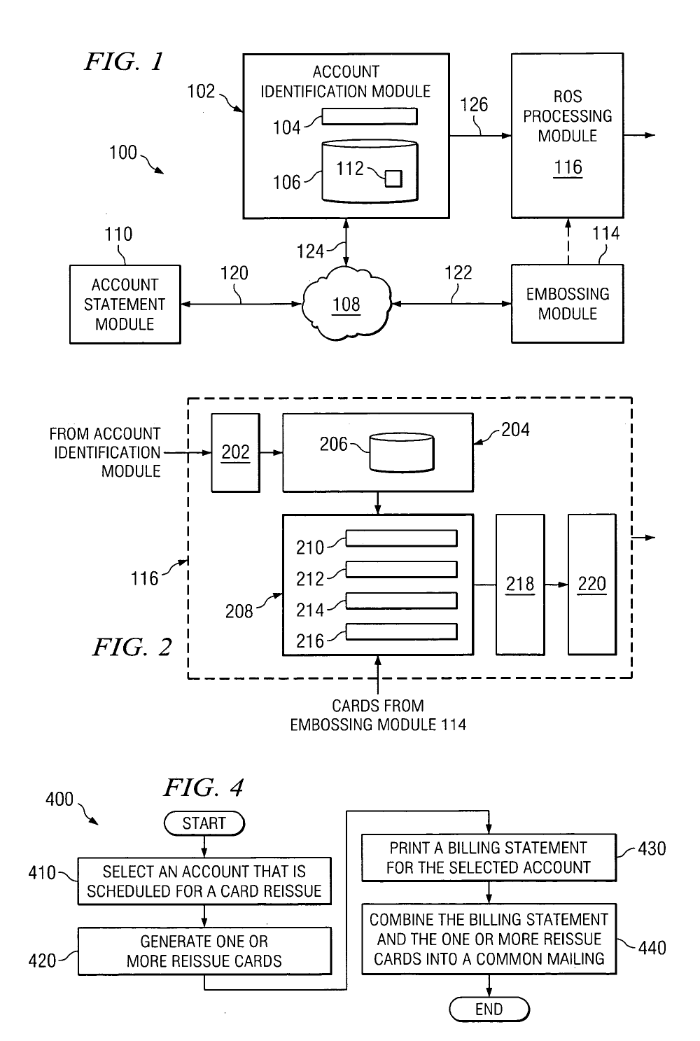

FIG. 1 is a block diagram of one embodiment of a mailing system 100 capable of combining a billing statement with one or more reissue cards into a common mailing. FIG. 1 illustrates just one example embodiment of system 100. It should be appreciated that other embodiments of system 100 may be used without departing from the scope of the present disclosure. As used throughout this document, the term “reissue card” refers to any card (including an upgrade card) that replaces or supercedes an existing card relating to and/or identifying an account of one or more entities. Moreover, the term “card reissue” refers to any event associated with an account that necessitates the issuance of a reissue card to the owner of the account.

In this example, system 100 includes an account statement module 110 capable of performing one or more desired computing and/or communicating functions. For example, account statement module 110 may be capable of receiving, storing, organizing, processing, correlating, and/or communicating account information or data for one or more accounts. Account statement module 110 may comprise any device or combination of devices that may include one or more hardware, software, and/or firmware modules. In this particular embodiment, account statement module 110 comprises a billing statement system capable of preparing routine billing statements. Account statement module 110 can prepare the routine billing statements for particular accounts on, for example, a bi-monthly, a monthly, a quarterly, a semi-annual, or any other appropriate billing cycle.

In one particular embodiment, account statement module 110 communicates account information associated with those accounts that have reached the end of their routine billing cycle through a network 108. In various embodiments, account statement module 110 can, on a daily basis, communicate the account information for those accounts that have reached the end of their billing cycle on that particular day. In other embodiments, account statement module 110 can communicate, on a bi-weekly basis, the account information for those accounts that have reached the end of their billing cycle during a particular portion of a current week. Account information can include, for example, an account number, a name of the account owner, an address of the account owner, a telephone number of the account owner, a credit limit on the account, one or more transactions associated with the account, an activation date of the account, an expiration date for the account, an amount due on the account, or any other appropriate account information.

In this example, account statement module 110 communicates the account information through a communications link 120 coupled to network 108 and to account statement module 110. As used throughout this document, the term “couple” and/or “coupled” refers to any direct or indirect communication between two or more elements, whether or not those elements are in physical contact with one another. In other embodiments, account statement module 110 may be capable of receiving, processing, and/or storing requests for account information from network 108.

Network 108 may comprise any wireless network, wireline network, or combination of wireless and wireline networks capable of supporting communication between network elements using ground-based and/or space-based components. For example, network 108 may comprise a data network, a public switched telephone network (PSTN), an integrated services digital network (ISDN), a local area network (LAN), a wide area network (WAN), a metropolitan area network (MAN), all or a portion of the global computer network known as the Internet, and/or other communication systems or combination of communication systems at one or more locations.

System 100 also includes an account identification module 102 coupled to network 108 through communications link 124. Account identification module 102 may comprise any computing and/or communicating device or combination of devices capable of storing, processing, communicating, and/or receiving account information associated with one or more accounts. As non-limiting examples, account identification module 102 may include a web server, a work station, a mainframe computer, a mini-frame computer, a desktop computer, a laptop computer, a personal digital assistant, a wireless device, and/or any other computing or communicating device or combination of devices. In operation, account identification module 102 may execute with any of the well-known MS-DOS, PC-DOS, OS-2, MAC-OS, WINDOWS™, LINUX, UNISYS, UNIX, or other appropriate operating systems.

In this particular embodiment, account identification module 102 receives from account statement module 110 the account information for those accounts that have reached the end of their routine billing cycle. Moreover, account identification module 102 selects from those accounts one or more accounts that are scheduled for a card reissue. In this example, account identification module 102 receives, on a daily basis, the account information for those accounts that have reached the end of their routine billing cycle on that particular day. Moreover, account identification module 102 selects from those accounts one or more accounts that are scheduled for a card reissue on that particular day.

In various embodiments, account identification module can include one or more processors 104 capable of generating one or more reissue card generation requests associated with the selected accounts. In some embodiments, processors 104 operate to select the one or more accounts based at least in part on one or more process parameters 112 stored on a memory 106. As non-limiting examples, the one or more process parameters 112 can include, for example, that the account is scheduled for a card reissue, the account is capable of having a one page or a few page billing statement, the account has no more than two cards to reissue, the account has no more than four cards to reissue, one or more particular business rules, and/or any other desired process parameter or parameters. Although specific examples are provided concerning the number of cards to reissue, any number of reissue cards may be reissued without departing from the scope of the present disclosure.

Memory 106 may include any hardware, software, firmware, or combination thereof operable to store and facilitate retrieval of information. Memory 106 may store information using any of a variety of data structures, arrangements, and/or compilations. Memory 106 may, for example, include a hard disk, a dynamic random access memory (DRAM), a static random access memory (SRAM), or any other suitable volatile or nonvolatile storage and retrieval device or combination of devices.

Account identification module 102 operates to communicate one or more reissue card generation requests to an embossing module 114 through network 108. In this example, embossing module 114 operates to receive the reissue card generation requests and to generate one or more reissue cards for the selected accounts. In this particular embodiment, each reissue card includes a magnetic strip that is capable of storing account information. Moreover, embossing module 114 writes at least some of the account information of a particular account to the magnetic strip of a particular reissue card. In other embodiments, embossing module 114 can operate to generate the one or more reissue cards associated with the selected accounts and to generate other cards for other accounts.

Embossing module 114 may comprise any device or combination of devices capable of generating one or more reissue cards and of writing at least some of the account information to the magnetic strips of the reissue cards. In various embodiments, embossing module 114 may include one or more hardware, software, and/or firmware modules capable of assisting with the generation of the reissue cards. In some embodiments, embossing module 114 can include a memory that stores all the reissue card generation requests.

In this particular embodiment, embossing module 114 includes a tracking and/or flagging system that enables embossing module 114 to identify and/or correlate each reissue card to a particular reissue card generation request. In other embodiments, the tracking and/or flagging system can allow a plastic inventory tracking system to uniquely identify each of the one or more reissue cards amongst a plurality of other cards generated by embossing module 114.

After embossing module 114 generates the reissue cards for each of the selected accounts, the reissue cards are transported to and/or loaded in a reissue on statement (ROS) processing module 116. In some embodiments, the reissue cards can be automatically transported to and/or loaded in ROS processing module 116. In other embodiments, the reissue cards can be manually transported to and loaded in ROS processing module 116.

Account identification module 102 also communicates account information associated with the selected accounts that are scheduled for a card reissue to ROS processing module 116 through a communications link 126. Although in this example account identification module 102 communicates account information to ROS processing module 116 via communications link 126, account identification module 102 could alternatively communicate the account information through network 108 or any other appropriate communication channel without departing from the scope of the present disclosure.

ROS processing module 116 may comprise any device or combination of devices capable of combining a billing statement and one or more reissue cards into a common mailing. In various embodiments, ROS processing module 116 may include one or more hardware, software, and/or firmware modules capable of contributing to combining the billing statement and the one or more reissue cards into the common mailing. For example, ROS processing module 116 may comprise a formatting engine, a receiving system, a generation module, and/or a combination of these or other devices.

In the illustrated embodiment, ROS processing module 116 generates a printed billing statement for each of the selected accounts that include a top section, a middle section, and a bottom section. The information associated with the selected accounts can be arranged within the sections in any desired format. In one particular example, the top section includes a payment remit stub, the middle section includes one or more transactions associated with the account, and bottom section includes marketing coupons and/or reissue card information. Although the billing statements in this example include three sections, other billing statement formats can be used without departing from the scope of the present disclosure. In some embodiments, ROS processing module 116 can print the billing statement for a particular account that is scheduled for a card reissue upon identifying the account information associated with a particular reissue card.

ROS processing module 116 further operates to correlate the one or more reissue cards received from embossing module 114 with the printed billing statements for each of the selected accounts. In one particular embodiment, ROS processing module correlates each reissue card with a particular printed billing statement by reading the magnetic strip associated with each reissue card. The magnetic strip includes at least some of the account information for a particular account that is scheduled for a card reissue. In some embodiments, the account information retrieved from the magnetic strip can cause ROS processing module 116 to print the billing statement associated with a particular account.

In this particular embodiment, ROS processing module 116 combines at least the printed billing statement and the one or more reissue cards into a common mailing. In various embodiments, ROS processing module 116 can control the placement and/or attachment of the one or more reissue cards to the printed billing statement. For example, ROS processing module 116 can place the one or more reissue cards to minimize the impact of the cards on the financial information on the billing statements. In some embodiments, ROS processing module 116 can affix the one or more reissue cards to one or more separate mailing inserts and then combine the inserts with the printed billing statement into a common mailing. In other embodiments, ROS processing module 116 can combine the printed billing statement and the one or more reissue cards by, for example, affixing or attaching the one or more reissue cards to a particular section of the billing statement.

In one particular embodiment, ROS processing module 116 combines the printed billing statement and the one or more reissue cards by affixing the one or more reissue cards to a third section of the printed billing statement. Although ROS processing module 116 affixes the one or more reissue cards to the third section of the printed billing statement in this example, the one or more reissue cards can be affixed to the printed billing statement at any other desired location without departing from the scope of the present disclosure. ROS processing module 116 can affix the one or more reissue cards to the printed billing statement by, for example, gluing, taping, or any other appropriate method of attachment.

In the illustrated embodiment, ROS processing module 116 operates to combine a printed billing statement for each selected account that is scheduled for a card reissue and the one or more reissue cards associated with each selected account into a common mailing. In other embodiments, ROS processing module 116 may be capable of combining the printed billing statement for each selected account, the one or more reissue cards for each selected account, one or more regulatory inserts, one or more “in-statement” letters, marketing materials, and/or a combination of these or other inserts into a common mailing.

In various embodiments, ROS processing module 116 can include a quality assurance system that operates to compare the reissue card to the printed billing statement. In some embodiments, the quality assurance system can compare a number associated with the one or more reissue cards to an account number and/or a bar code on the printed billing statement. In some cases, upon identifying one or more reissue cards affixed to the wrong billing statement, the quality assurance system operates to stop ROS processing module 116. In other embodiments, the quality assurance system can divert a printed billing statement that has one or more reissue cards affixed for a manual quality assurance check. In those cases, the quality assurance system can divert, for example, every tenth, fiftieth, hundredth, or more printed billing statement that has one or more reissue cards affixed for a manual quality assurance check.

One aspect of this disclosure recognizes that combining a printed billing statement and one or more reissue cards into a common mailing can reduce the costs associated with providing reissue cards to account owners. In particular, by combining a printed billing statement and one or more reissue cards into a common mailing, businesses may be able to reduce postage expenses that they would otherwise incur by providing separate mailings. Businesses may also be able to reduce the expenses associated with consumables used to create the separate mailings. Another aspect of this disclosure recognizes that combining the printed billing statement and one or more reissue cards into the common mailing may increase the number of account owners that activate the reissue cards. That is, by combining a printed billing statement and one or more reissue cards into a common mailing, account owners may be reminded and/or influenced to activate the reissue card for their account.

In the illustrated embodiment, system 100 includes at least communications links 120, 122, and 124, each operable to facilitate the communication of data to and/or from network 108. System 100 also includes communication link 126 operable to facilitate the communication of data between AIM module 102 and ROS processing module 116. Communications links 120, 122, 124, and 126 may include any hardware, software, firmware, or combination thereof. In various embodiments, communications links 120, 122, 124, and 126 may comprise communications media capable of assisting in the communication of analog and/or digital signals. Communications links 120, 122, 124, and 126 may, for example, comprise a twisted-pair copper telephone line, a fiber optic line, a Digital Subscriber Line (DSL), a wireless link, a USB bus, a PCI bus, an ethernet interface, or any other suitable interface operable to assist in the communication within system 100.

In operation, account statement module 110 communicates account information associated with those accounts that have reached the end of their routine billing cycle to account identification module 102. In this particular embodiment, account statement module 110 includes a program that automatically initiates the communication of the account information for those accounts that have reached the end of their routine billing cycles. Although account statement module 110 automatically initiates the communication of the account information in this example, account identification module 102 could communicate a request to account statement module 110 to initiate the communication of the account information without departing from the scope of the present disclosure.

Account statement module 110 can communicate the account information for those accounts that have reached the end of their routine billing cycle on, for example, a daily basis, a bi-weekly basis, or any other appropriate time period. In this particular embodiment, account statement module 110 communicates, on a daily basis, the account information for those accounts that have reached the end of their routine billing cycle on that particular day. For example, if one or more accounts end their routine billing cycles on the twelfth day of the month, then account statement module 110 communicates the account information associated with such accounts to account identification module 102 on the twelfth of such month.

Account identification module 102 receives the account information for those accounts that have reached the end of their routine billing cycle and selects from those accounts one or more accounts that are scheduled for a card reissue. In this particular embodiment, account identification module 102 includes processor 104 that selects the one or more account that are scheduled for a card reissue based at least in part on one or more process parameters 112 stored in memory 106. In this example, processor 104 selects the one or more accounts by determining that the account is scheduled for a card reissue, the account is capable of having a one page billing statement, and the account has no more than two cards to reissue. Although this example implements specific process parameters, any other process parameters or business rules may be implemented without departing from the scope of the present disclosure. In this embodiment, account identification module 102 generates one or more reissue card generation requests for the selected accounts that are scheduled for a card reissue.

In this example, account identification module 102 communicates the one or more reissue card generation requests associated with the selected accounts that are scheduled for a card reissue to embossing module 114 through network 108. Upon receiving the one or more reissue card generation requests, embossing module 114 generates the reissue cards for each of the selected accounts that are scheduled for a card reissue. In this particular embodiment, embossing module 114 writes at least some of the account information of a particular account to the magnetic strip of a particular reissue card.

In some embodiments, embossing module 114 can operate to track the reissue cards for each of the selected accounts that are scheduled for a card reissue and to separate the reissue card from the other cards. In other embodiments, embossing module 114 can operate to generate the reissue cards for each of the selected accounts in batches that are separate from batches generated for other cards.

Account identification module 102 also communicates the account information associated with the selected accounts that are scheduled for a card reissue to ROS processing module 116. Moreover, ROS processing module 116 operates to receive the reissue cards associated with the selected accounts that are scheduled for a card reissue from embossing module 114. In some embodiments, the reissue cards can be automatically transmitted and/or loaded into ROS processing module 116. In other embodiments, the reissue cards can be manually transmitted and/or loaded into ROS processing module 116.

In this particular embodiment, ROS processing module 116 prints the billing statement for each of the selected accounts and combines each billing statement with the appropriate one or more reissue cards for insertion into a common mailing. In some embodiments, ROS processing module 116 prints the billing statement for a particular account upon reading the account information for the particular account from a magnetic strip of particular a reissue card.

This particular embodiment illustrates account statement module 110, embossing module 114, and ROS processing module 116 as residing remotely from account identification module 102. In an alternative embodiment, each of account identification module, account statement module 110, embossing module 114, and ROS processing module 116 can reside locally. Moreover, any one or more of account identification module, account statement module 110, embossing module 114, and ROS processing module 116 can be combined into a common module.

FIG. 2 is a block diagram of one embodiment of ROS processing module 116 that is capable of combining a billing statement with one or more reissue cards for insertion into a common mailing. FIG. 2 illustrates just one example embodiment of ROS processing module 116. It should be appreciated that other embodiments of ROS processing module 116 may be used without departing from the scope of the present disclosure.

In this example, ROS processing module 116 includes a formatting engine 202 that is capable of receiving the account information associated with the selected accounts that are scheduled for a card reissue. Moreover, formatting engine 202 operates to format the account information for each of the selected accounts into one or more printable billing statement files for each account. Formatting engine 202 may comprise, for example, a web server, a work station, a mainframe computer, a mini-frame computer, a desktop computer, a laptop computer, a personal digital assistant, a wireless device, and/or any other computing or communicating device or combination of devices. In operation, formatting engine 202 may execute with any of the well-known MS-DOS, PC-DOS, OS-2, MAC-OS, WINDOWS™, LINUX, UNISYS, UNIX, or other appropriate operating systems.

In this particular embodiment, formatting engine 202 communicates each of the printable billing statement files to a receiving system 204. Receiving system 204 operates to store each of the printable billing statement files on a memory 206. Memory 206 may include any hardware, software, firmware, or combination thereof operable to store and facilitate retrieval of information. Memory 606 may store information using any of a variety of data structures, arrangements, and/or compilations. Memory 206 may, for example, include a hard disk, a dynamic random access memory (DRAM), a static random access memory (SRAM), or any other suitable volatile or nonvolatile storage and retrieval device or combination of devices.

Receiving system 204 may comprise any computing and/or communicating device or combination of devices capable receiving, storing, organizing, processing, correlating, and/or communicating one or more printable billing statement files associated with each of the selected accounts that are scheduled for a card reissue. Receiving system 204 may include a web server, a work station, a mainframe computer, a mini-frame computer, a desktop computer, a laptop computer, a personal digital assistant, a wireless device, and/or any other computing or communicating device or combination of devices. In operation, receiving system 204 may execute with any of the well-known MS-DOS, PC-DOS, OS-2, MAC-OS, WINDOWS™, LINUX, UNISYS, UNIX, or other appropriate operating systems.

ROS processing module 116 also includes an ROS generation module 208 coupled to receiving module 204. In this particular embodiment, ROS generation module 208 operates to print a billing statement for each selected account and combines the printed billing statement with one or more reissue cards associated with a particular selected account for insertion into a common mailing. ROS generation module 208 may comprise any device or combination of devices that may include one or more hardware, software, and/or firmware modules.

In the illustrated embodiment, ROS generation module 208 includes a processing system 210 that controls the operation of ROS generation module 208. Processing system 210 may include any computing and/or communication device or combination of devices. Processing system 210 may include a web server, a work station, a mainframe computer, a mini-frame computer, a desktop computer, a laptop computer, a personal digital assistant, a wireless device, and/or any other computing or communicating device or combination of devices. In operation, processing system 210 may execute with any of the well-known MS-DOS, PC-DOS, OS-2, MAC-OS, WINDOWS™, LINUX, UNISYS, UNIX, or other appropriate operating systems.

Processing system 210 determines that one or more reissue cards have been loaded into ROS generation module 208 and to correlate the one or more reissue cards with the printable billing statement file for each of the selected accounts. In some embodiments, processing system 210 can correlate the printable billing statement file for a particular account by reading a magnetic strip of a particular reissue card.

In this example, ROS generation module 208 also includes a card reading device 212 that operates to identify account information associated with a particular reissue card. In this example, card reading device 212 operates to identify the account information for a particular reissue card by reading a magnetic strip for a particular reissue card. Although card reading device 212 reads the magnetic strip in this example, card reading device 212 could identify the account information in any other appropriate manner without departing from the scope of the present disclosure.

Card reading device 212 communicates the account information received from a particular reissue card to processing system 210 coupled to card reading device 212. Processing system 210 identifies the account information and communicates a request to receiving system 204 for a printable billing statement file that corresponds to the account information received from card reader device 212. Upon receiving the request for a particular printable billing statement file, receiving system 204 identifies the appropriate file and communicates such file to processing system 210.

In this particular embodiment, processing system 210 communicates the printable billing statement file to a printing system 214. In some embodiments, printing system 214 can receive the printable billing statement files directly from receiving system 204. In other embodiments, printing system 214 can receive the printable billing statement files from indirectly from receiving system 204. That is, printing system 214 may receive the printable billing statement files from receiving system 204 through processing module 212 or through another device or network.

In this particular embodiment, printing system 214 prints the billing statement for a particular account that is scheduled for a card reissue upon receiving the printable billing statement file for a particular account from processing system 210. In this example, printing system 214 the printed billing statement for each of the selected accounts includes a top section, a middle section, and a bottom section. The information associated with the selected accounts can be arranged within the sections in any desired format. In one particular example, the top section includes a payment remit stub, the middle section includes one or more transactions associated with the account, and bottom section includes marketing coupons and/or reissue card information. Although the billing statements in this example include three sections, other formats can be used without departing from the scope of the present disclosure.

In this example, ROS generation module 208 communicates the printed billing statement and the one or more reissue cards for a particular account to a combining system that combines the printed billing statement and the one or more reissue cards for each of the selected accounts for insertion into a common mailing. Combining system 216 can include any device or combination of devices that may include one or more hardware, software, and/or firmware modules. In various embodiments, combining system 216 can control the placement and/or attachment of the one or more reissue cards to the printed billing statement. For example, combining system 216 can place the one or more reissue cards so as to minimize the impact of the cards on the financial information on the printed billing statement.

In some embodiments, combining system 216 can affix the one or more reissue cards to a separate mailing insert and then combine the insert with the printed billing statement for insertion into a common mailing. In other embodiments, combining system 216 can combine the printed billing statement and the one or more reissue cards by, for example, affixing or attaching the one or more reissue cards to a particular section of the billing statement.

In this particular embodiment, combining system 216 operates to affix the one or more reissue cards to the printed billing statement by taping the reissue cards to a third section of the printed billing statement. Although combining system 216 tapes the one or more reissue cards to a third section of the billing statement in this example, the one or more reissue cards can be affixed to the printed billing statement at any other desired location without departing from the scope of the present disclosure. Moreover, combining system 216 can affix the one or more reissue cards to the printed billing statement by, for example, gluing, taping, or any other appropriate method of attachment.

ROS processing module 116 also includes a quality assurance system 218 that operates to compare the reissue card to the printed billing statement. Quality assurance system 218 can comprise any device or combination of devices that may include one or more hardware, software, and/or firmware modules capable of comparing the reissue card to the printed billing statement. In this particular embodiment, quality assurance system 218 compares a number associated with the one or more reissue cards to an account number and/or a bar code on the printed billing statement. Upon identifying a reissue card affixed to the wrong billing statement, the quality assurance system operates to stop ROS generation module 208. In other embodiments, quality assurance system 218 can divert a printed billing statement that has one or more reissue cards affixed for a manual quality assurance check. In those cases, quality assurance system 218 can divert, for example, every tenth, fiftieth, hundredth, or more printed billing statement that has one or more reissue cards affixed for a manual quality assurance check.

In this particular embodiment, ROS processing module 116 also includes a mailing module 220 that is capable of placing the printed billing statement and the one or more reissue cards into a common mailing. Mailing module 220 can comprise any device or combination of devices that may include one or more hardware, software, and/or firmware modules capable of placing the printed billing statement and the one or more reissue cards into a common mailing. In some embodiments, mailing module 220 may be capable of placing the printed billing statement, the reissue cards, any regulatory inserts, any “in-statement” letters, and/or any marketing materials into a common mailing. In other embodiments, mailing module 220 may be capable of folding the combined printed billing statement and one or more reissue cards.

In this particular embodiment, ROS generation module 208 resides independent from quality assurance system 218 and mailing system 220. In an alternative embodiment, ROS generation module 208 could include quality assurance system 218 and/or mailing system 220.

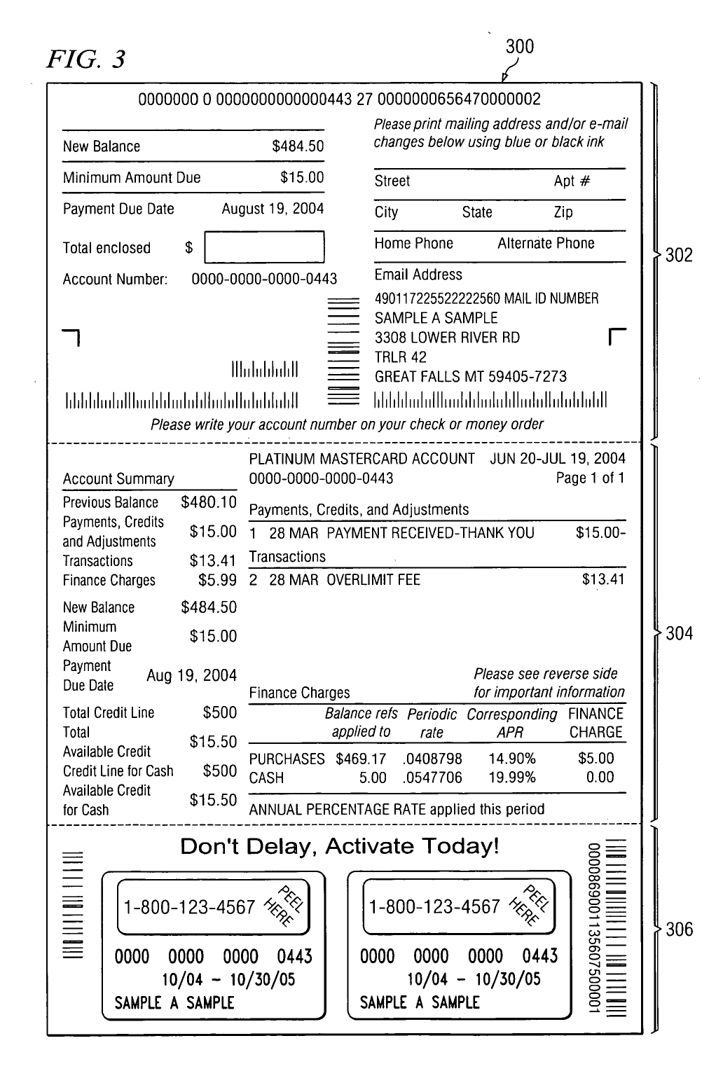

FIG. 3 is one embodiment of a billing statement 300 capable of being combined with one or more reissue cards in a common mailing. FIG. 3 illustrates just one example embodiment of a billing statement. It should be appreciated that other embodiments of a billing statement may be used without departing from the scope of the present disclosure. In this example, billing statement 300 includes three sections 302-306. Although billing statement 300 includes three sections 302-306 in this example, billing statement 300 could include any other number of sections without departing from the scope of the present disclosure.

In one non-limiting example, an ROS processing module, such as ROS processing module 116 of FIG. 1, generates billing statement 300. Billing statement 300 includes a top section 302, a middle section 304, and a bottom section 306. In this example, top section includes a payment remit stub, while middle section 304 includes one or more transactions associated with the account. Moreover, bottom section 306 includes marketing coupons and/or a place for affixing or attaching on or more reissue cards.

In particular embodiment, one or more reissue cards are affixed or attached to bottom section 306. In an alternative embodiment, one or more reissue cards could be affixed or attached to top section 302 and/or middle section 304. In yet another alternative embodiment, the one or more reissue cards could be affixed to one or more separate inserts associated with billing statement 300. In that embodiment, an ROS processing module could format billing statement 300 to combine middle section 304 and bottom section 306 into one contiguous section to provide additional space for account transactions and/or other account information.

FIG. 4 is a flow chart illustrating an exemplary method for combining a billing statement and one or more reissue cards in a common mailing. In one particular embodiment, a billing statement and one or more reissue cards may be combined into a common mailing through system 100 of FIG. 1. Although system 100 is used in this example, other systems may be used without departing from the scope of the present disclosure.

In this embodiment, account statement module 110 communicates account information associated with those accounts that have reached the end of their routine billing cycle to account identification module 102. Account statement module 110 can communicate the account information for those accounts that have reached the end of their routine billing cycle on, for example, a daily basis, a bi-weekly basis, or any other appropriate time period. In this particular embodiment, account statement module 110 communicates, on a daily basis, the account information for those accounts that have reached the end of their routine billing cycle on that particular day.

Account identification module 102 receives the account information for those accounts that have reached the end of their routine billing cycle. In this example, method 400 begins at step 410 where account identification module 102 selects from those accounts one or more accounts that are scheduled for a card reissue. In this particular embodiment, account identification module 102 utilizes one or more process parameters and/or business rules to select the one or more account that are scheduled for a card reissue. For example, account identification module 102 may select the one or more accounts because each of the selected accounts are scheduled for a card reissue, are capable of having a few page billing statement, and have no more than eight cards to reissue. Although this example implements specific process parameter, any other process parameters or business rule may be implemented without departing from the scope of the present disclosure.

In various embodiments, account identification module 102 can generate one or more reissue card generation requests for the selected accounts that are scheduled for a card reissue and communicate those requests to an embossing module. In this example, method 400 generates the reissue cards for each of the selected accounts at step 420. In most cases, upon receiving the one or more reissue card generation requests, embossing module 114 generates the reissue cards for each of the selected accounts that are scheduled for a card reissue and writes at least some of the account information of a particular account to a magnetic strip of a particular reissue card.

Account identification module 102 also communicates the account information associated with the selected accounts that are scheduled for a card reissue to ROS processing module 116. Moreover, ROS processing module 116 operates to receive the reissue cards associated with the selected accounts that are scheduled for a card reissue from embossing module 114. In some embodiments, the reissue cards can be automatically transmitted and/or loaded into ROS processing module 116. In other embodiments, the reissue cards can be manually transmitted and/or loaded into ROS processing module 116. As a specific embodiment, the structure and function of the ROS processing module can be substantially similar to ROS module 116 of FIG. 2.

In various embodiments, ROS processing module 116 may include a formatting engine, such as formatting engine 202 of FIG. 2, that is capable of receiving the account information associated with the selected accounts that are scheduled for a card reissue. Moreover, the formatting engine may operate to format the account information for each of the selected accounts into one or more printable billing statement files for each account. In some embodiments, the formatting engine may be capable of communicating each of the printable billing statement files to a receiving system, such as receiving system 204 of FIG. 2. The receiving system can operate to store each of the printable billing statement files in memory.

In this example, method 400 operates to print a billing statement for the selected accounts at step 430. In various embodiments, ROS processing module 116 can operate to correlate the one or more reissue cards received from embossing module 114 with the printed billing statements for each of the selected accounts. In some embodiments, ROS processing module 116 can correlate each reissue card with a particular printed billing statement by reading the magnetic strip associated with each reissue card. In those embodiments, the magnetic strip includes at least some of the account information for a particular account that is scheduled for a card reissue. In some embodiments, the account information retrieved from the magnetic strip can cause ROS processing module 116 to print the billing statement associated with a particular account.

In this example, method 400 operates to combine the printed billing statement and the one or more reissue cards into a common mailing at step 440. In various embodiments, ROS processing module 116 can control the placement and/or attachment of the one or more reissue cards to the printed billing statement. In some embodiments, ROS processing module 116 can affix the one or more reissue cards to one or more separate mailing inserts and then combine the inserts with the printed billing statement into a common mailing. In other embodiments, ROS processing module 116 can combine the printed billing statement and the one or more reissue cards by, for example, affixing or attaching the one or more reissue cards to a particular section of the billing statement.

In one particular embodiment, ROS processing module 116 combines the printed billing statement and the one or more reissue cards by affixing the one or more reissue cards to a third section of the printed billing statement. ROS processing module 116 can affix the one or more reissue cards to the printed billing statement by, for example, gluing, taping, or any other appropriate method of attachment. In the illustrated embodiment, ROS processing module 116 operates to combine a printed billing statement for each selected account that is scheduled for a card reissue and the one or more reissue cards associated with each selected account into a common mailing. In other embodiments, ROS processing module 116 may be capable of combining the printed billing statement for each selected account, the one or more reissue cards for each selected account, one or more regulatory inserts, one or more “in-statement” letters, and/or marketing materials into a common mailing.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

1. A system for mailing account card, the system comprising:
an account identification module operable to select an account that is scheduled for a card reissue;
an embossing module operable to generate one or more reissue cards associated with the selected account; and
a reissue on statements (ROS) generation module operable to print the billing statement associated with the selected account and to combine the billing statement and the one or more reissue cards for insertion into a common mailing.

2. The system of claim 1, wherein the account identification module selects the account from a plurality of accounts based at least in part on the selected account satisfying one or more process parameters.

3. The system of claim 2, wherein the one or more parameters comprise a one page monthly billing statement and no more than two reissue cards.

4. The system of claim 2, wherein the one or more parameters comprise a few page monthly billing statement and no more than eight reissue cards.

5. The system of claim 1, wherein the account identification module has access to account information stored in a separate billing statement processing system.

6. The system of claim 1, wherein the account identification module operates to identify a plurality of accounts that are scheduled for a card reissue.

7. The system of claim 1, wherein the account identification module communicates the information of the selected account to the formatting module.

8. The System of claim 1, wherein the embossing module resides remotely from the account identification module.

9. The System of claim 1, wherein the embossing module operates to receive one or more reissue card generation requests associated with the selected account from the account identification module.

10. The System of claim 9, wherein the embossing module attaches a unique identifier to each of the one or more reissue card generation requests.

11. The system of claim 1, wherein the one or more reissue cards comprises an upgrade card.

12. The system of claim 1, wherein the ROS generation module operates to combine the printed billing statement and the one or more reissue cards by affixing the one or more reissue cards to a panel associated with the billing statement.

13. The system of claim 1, wherein the ROS generation module is further operable to:
receive the one or more reissue cards;
identify the selected account associated with the one or more reissue cards; and
affix the one or more reissue cards to the printed billing statement for the selected account.

14. The system of claim 13, wherein the ROS generation module identifies the selected account by reading the selected account information from a magnetic strip associated with the one or more reissue cards.

15. The system of claim 1, further comprising a memory module coupled to the ROS generation module, the memory module operable to store the billing statement for the selected account.

16. The system of claim 1, further comprising a formatting module operable to receive information associated with the selected account from the account identification module and to format the information into a printable billing statement file for the selected account.

17. The system of claim 16, wherein the formatting module formats each billing statement to include a top section having a payment remit stub, a middle section having statement information, and a bottom section having a reissue card section.

18. A method for mailing account cards, comprising:
selecting an account that is scheduled for a card reissue from a plurality of accounts;
generating one or more reissue cards associated with the selected account;
formatting information associated with the selected account;
printing a billing statement for the selected account; and
combining the billing statement and the one or more reissue cards associated with the selected account into a common mailing.

19. The method of claim 18, wherein selecting the account is based at least in part on the account satisfying one or more parameters.

20. The method of claim 18, wherein formatting the information associated with the selected account into the billing statement comprises converting the information associated with the selected account into a printable file.

21. The method of claim 18, wherein the billing statement comprises a top section having a payment remit stub, a middle section having statement information, and a bottom section having a reissue card section.

22. The method of claim 18, wherein combining the billing statement and the one or more reissue cards comprises affixing the one or more reissue cards to the billing statement.

23. The method of claim 18, wherein combining the billing statement and the one or more reissue cards comprises:
receiving the one or more reissue cards;
identifying the selected account associated with the one or more reissue cards;
after identifying the selected account associated with the one or more reissue cards, printing the billing statement for the selected account; and
affixing the one or more reissue cards to the printed billing statement for the selected account.

24. The method of claim 23, wherein identifying the selected account comprises reading a magnetic strip associated with the one or more reissue cards to identify the selected account.

25. The method of claim 23, further comprising storing the billing statement for the selected account in a memory module coupled to the ROS generation module.

26. The method of claim 18, further comprising identifying a plurality of accounts that are scheduled for a card reissue.

27. The method of claim 18, wherein generating the one or more reissue cards comprises:
receiving one or more reissue card generation requests associated with the selected account;
attaching a unique identifier to each of the one or more reissue card generation requests; and
printing the one or more reissue cards.

28. A reissue on statements (ROS) processing system, comprising:
a formatting engine operable to receive account information for a selected account that is scheduled for a card reissue and to format the account information into a printable billing statement file;
a printing system operable to generate a billing statement for the selected account based at least in part on the printable billing statement file; and
a combining system operable to receive one or more reissue cards associated with the selected account and to combine the printed billing statement and the one or more reissue cards for insertion into a common mailing.
